(19) United States
(12) Patent Application Publication
(10) Pub. No.: US 2014/0319064 A1
(43) Pub. Date: Oct. 30, 2014

(54) Ethylenediamine core, octamethylenephosphonic acid terminated, PAMAM dendrimer and its use as antiscalant

(71) Applicant: Tongji University, Shanghai (CN)

(72) Inventors: Fengting Li, Shanghai (CN); Bingru Zhang, Shanghai (CN); Hongtao Wang, Shanghai (CN); Yinan Wu, Shanghai (CN)

(73) Assignee: Tongji University

(21) Appl. No.: 13/943,672

(22) Filed: Jul. 16, 2013

(30) Foreign Application Priority Data
Apr. 27, 2013 (CN) 201310152319.1

(51) Int. Cl. C02F 5/14

(52) U.S. Cl. CPC C02F 5/14
USPC 210/700; 564/15

(57) ABSTRACT

A preparation method of ethylenediamine core, octamethylenephosphonic acid terminated, PAMAM dendrimer and application thereof is provided, wherein terminal amino groups of ethylenediamine core, 0 generation, PAMAM dendrimer is modified by methylene phosphonic acid. The ethylenediamine core, octamethylenephosphonic acid terminated, PAMAM dendrimer has an excellent performance to inhibit scales of CaCO₃, CaSO₄ and Ca₃(PO₄)₂, a very high calcium tolerance, and excellent dispersing performance. The ethylenediamine core, octamethylenephosphonic acid terminated, PAMAM dendrimer is used as an antiscalant in industrial water treatment, and is suitable for the industrial water treatment of boiler, cooling, desalination, and oil production, etc., especially for the industrial water treatment under high calcium concentration.

### BACKGROUND OF THE PRESENT INVENTION

1. Field of Invention

The present invention relates to the technical field of water treatment to inhibit the formation of scales. More particularly, the present invention relates to a process for producing ethylenediamine core, octamethylenephosphonic acid terminated, PAMAM dendrimer and methods of inhibiting scales formation in industrial water systems, such as boiler, cooling, desalination, and oil production, especially in the industrial water treatment under the condition of high calcium concentration.

2. Description of Related Arts

In industrial water treatment systems, feed water from rivers, lakes, ponds, etc., normally contains large amounts of various dissolved ions, such as Ca²⁺, CO₃²⁻, SO₄²⁻ and PO₄³⁻. As water evaporates or concentrates, these dissolved ions can precipitate and form scales, which accumulate on internal metal surfaces in contact with the water flowing through the system. Typical scales include calcium carbonate, calcium sulfate, and calcium phosphate, all of which can cause consequential losses of equipment efficiency.

Scales prevention can be achieved principally by the addition of tailor-made antiscalants including phosphonates containing one or more C—P(O)(OH)₂ groups and polymer-based carboxylic acids.

TABLE 1
Names, abbreviations, molecular weight, and structures of commercial phosphonates

| | Producing | |
|---|---|---|
| Name (Abbreviation) | age | Structure, Moecular weight and Phosphorus content |
| 1-hydroxyethylidene-1,1- diphosphonic acid (HEDP) | 1970s | 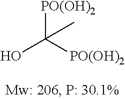 |
| 2-phosphonobutane-1,2,4- tricarboxylic acid (PBTCA) | 1980s | 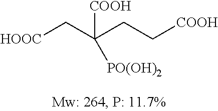 |
| Amino tri(methylene phosphonic acid) (ATMP) | 1970s | 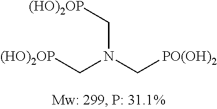 |
| Ethylene diamine tetra(methylene phosphonic acid) (EDTMP) | 1970s | 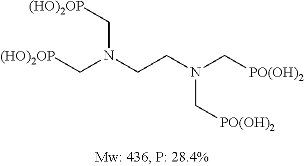 |
| Diethylene triamine penta(methylene phosphonic acid) (DTPMP) | 1970s | 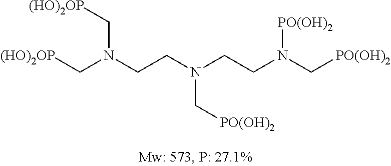 |
| Hexamethylene diamino tetra(methylene phosphonic acid) (HDTMP) | 1980s | 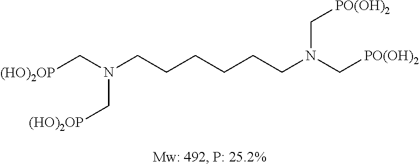 |
| Polyamino polyether tetra(methylene phosphonic acid) (PAPEMP) | 1990s | 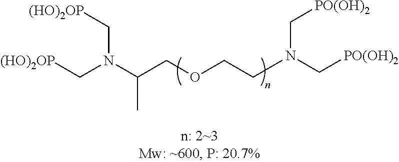 |

Phosphonates commonly used as antiscalants include 1-hydroxy ethylidene-1,1-diphosphonic acid (HEDP), 2-phosphonobutane-1,2,4-tricarboxylic acid (PBTCA), amido tri(methylene phosphonic acid) (ATMP), ethylene diamine tetra(methylene phosphonic acid) (EDTMP), diethylene triamine penta(methylene phosphonic acid) (DTPMP), hexamethylene diamine tetra(methylene phosphonic acid) (HDTMP), and polyamino polyether tetra(methylene phosphonic acid) (PAPEMP), as shown in table 1. Besides HEDP and PBTCA, phosphonate antiscalants are mainly compound-based amido methylene phosphonic acid. These phosphonates scale inhibitors are micromolecular compounds (Mw<600), except that PAPEMP is a macromolecule oligomer. These micromolecular phosphonates are widely used in industrial water treatment and occupy a large market share, because of low price, good performance of inhibiting calcium carbonate at low calcium ion concentration, and excellent corrosion inhibition performance. However, almost all of the micromolecular phosphonate antiscalants have poor calcium ions tolerance, so the micromolecular phosphonates easily react with the calcium ions to form calcium-phosphonate precipitates under the condition of high concentration calcium and/or high concentration of phosphonates, eventually degrading inhibiting efficiency of calcium carbonate scale. In addition, almost all of micromolecular phosphonates have poor inhibiting efficiency for calcium phosphate scale.

In order to inhibit the calcium phosphate scale, the polymer antiscalants are usually used. Compared with micromolecular phosphonates, the polymer antiscalants have better dispersing performance for calcium carbonate under high hardness, and they are more suitable for the condition of high hardness. As an example of phosphonate antiscalants-based amido methylene phosphonic acid, their molecular weights gradually increase from micromolecule compounds ATMP, EDTMP, DTPMP, and HTDMP to oligomer PAPEMP, but their phosphorus content and the calcium tolerance gradually increase. With respect to the micromolecule phosphonates, the macromolecular oligomer PAPEMP has a higher calcium tolerance, and is suitable for the condition of high hardness water. Under low calcium ion concentration, however, the inhibiting scale efficiency of PAPEMP is much poorer than micromolecular phosphonates, and a higher concentration of PAPEMP is required to achieve the same inhibiting scale efficiency. In addition, the amido-terminated polyether D230 (H₂N(CH₃)CH₂(OCH₂CH₂)ₙNH₂; wherein n=2˜3), which is the raw material for producing the PAPEMP, has a high price, in such a manner that the using cost of the water treatment is increased.

China is a country with very scarce water resources, but also a country having severe waste of the water resources, and low reused water. The shortage of the water resources is exacerbated by these factors. The water shortages in some areas have begun to restrict the further development of local social economy, so how to save the water resources has been on the agenda. Therefore, further increasing cycle of concentration of the industrial circulating cooling water has become the effective measures to save the water, to increase the water-use efficiency, and to protect the water resources. However, as cycle of concentration of the industrial circulating cooling water is increased and the calcium concentration is increased, the condition of water quality is harsher. Meanwhile, the more stringent environment protecting requirement makes higher requirement on the corrosion and scale inhibition treatment formula of the circulating cooling water. Therefore, it is necessary to seek a polymer phosphine scale inhibitor having low cost, high calcium tolerance, and low content of phosphorus.

In recent years, the dendrimer polyamide-amine (PAMAM) attracts more and more attention as a new type of polymer. Their application in water treatment technology is also increasingly significant. Particularly, amine-terminated PAMAM dendrimers exhibit excellent inhibitory activity for colloid silica scale.

Since the integer generation PAMAM dendrimers have a lot of terminal amino groups, the present invention modifies the terminal amino groups of the ethylenediamine core, 0 generation, PAMAM dendrimer with the methylene phosphonic acid to gain the oligomer methylene phosphonate scale inhibitor, which is ethylenediamine core, octamethylenephosphonic acid terminated, PAMAM dendrimer. Experiments show that the new type of dendrimer has a high calcium tolerance, and excellent inhibiting performance of calcium carbonate, calcium sulfate and calcium phosphate.

Up to now, reports about the polyamide-amine octa-methylene phosphonic acid, which is prepared by modifying the terminal amino groups of the ethylenediamine-cored polyamide-amine with the methylene phosphonic acid, can not be found across the world, and the structure of the polyamide-amine octa-methylene phosphonic acid is originated by the present invention.

### SUMMARY OF THE PRESENT INVENTION

The object of the present invention is to provide a preparation method of ethylenediamine core, octamethylenephosphonic acid terminated, PAMAM dendrimer and its use as antiscalant, in order to overcome the weakness of poor calcium tolerance and poor inhibiting effect for calcium phosphate scale of the conventional micromolecular phosphonates based methylene phosphonate.

Accordingly, in order to accomplish the above object, the present invention provides a preparation method of ethylenediamine core, octamethylenephosphonic acid terminated, PAMAM dendrimer, wherein a phosphonic acid radical (—P(O)(OH)₂) is connected to a terminal amino group of ethylenediamine core, 0 generation, PAMAM dendrimer (E-PAMAM(NH₂)₄) through a methylene to form ethylenediamine core, octa methylene phosphonic acid terminated, PAMAM dendrimer (E-PAMAM(PO₃H₂)₈), the dendrimer comprises a methylene phosphonic acid group, and the E-PAMAM(PO₃H₂)₈ has a structure illustrated as following.

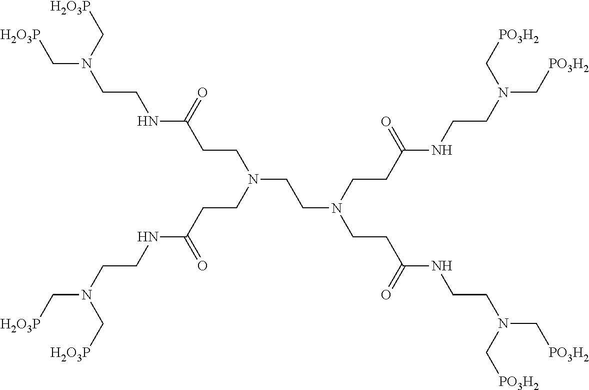

The general reaction equation and synthetic method can be represented as following.

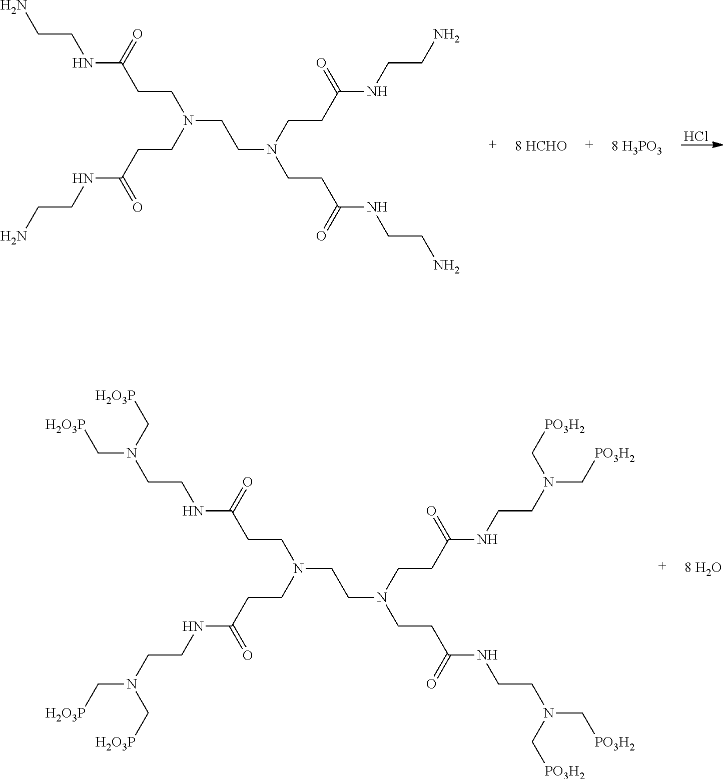

Phosphorous acid and concentrated hydrochloric acid are placed, respectively, in a four-necked flask equipped with a condenser, a stirring, a thermometer and a dropping funnel. Next, ethylenediamine core, 0 generation, PAMAM dendrimer solution (25% in water) is slowly added to above mixture solution with cooling and stirring in such a rate to maintain temperature less than 40° C. The resulting mixture is heated to 85˜90° C., and formaldehyde solution is then added to the mixture with stirring to form a reaction mixture. The temperature of reaction mixture maintained at 85˜90° C. for 1˜2 hour, and then is elevated to 102˜105° C. for a reflux period of 4˜6 hours. After the reflux, reaction mixture is concentrated for about 1 hour at 105° C., and meanwhile, hydrochloric acid is removed off by a HCl absorption bottle. Next, the reaction mixture is cooled to ambient temperature, to give an amber transparent liquid product with 30˜40% by weight, i.e., ethylenediamine core, octamethylenephosphonic acid terminated, PAMAM dendrimer (expressed as E-PAMAM(PO₃H₂)₈).

In the present invention, a molar ratio of the ethylenediamine core, 0 generation, PAMAM dendrimer ((expressed as E-PAMAM(NH₂)₄), phosphorous acid, formaldehyde and hydrochloric acid is 1:8.0˜8.2:10.0˜11.0:10.0˜10.5.

In the present invention, the ethylenediamine core, 0 generation, PAMAM dendrimer is purchased from SIGMA-ALDRICH Company, China. The effective concentration is 20% (methanol solution). When using the ethylenediamine core, 0 generation, PAMAM dendrimer, the methanol is removed by vacuum, and then the E-PAMAM(NH₂)₄ is dissolved in deionized water by weigh of 25%. Ethylenediamine core, 0 generation, PAMAM dendrimer has the following formula:

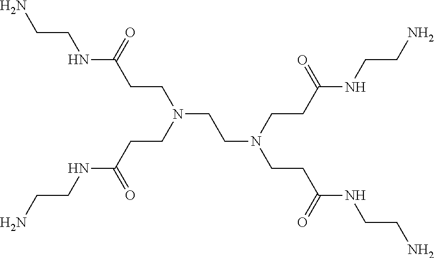 [SMILES: NCCNC(=O)CCN(CCC(=O)NCCN)CCN(CCC(=O)NCCN)CCC(=O)NCCN]

In the present invention, commercially available phosphorous acid (H₃PO₃) is adopted with a purity of 99.0%.

In the present invention, commercially available formaldehyde (HCHO) is provided about 37% by weigh.

In the present invention, commercially available concentrated hydrochloric acid is provided about 37% by weigh.

The ethylenediamine core, octamethylenephosphonic acid terminated, PAMAM dendrimer prepared according to the present invention is a dendrimer having a terminal group of methylene phosphonic acid and a phosphorus content of 19.6%, which is less than that of other products of methylene phosphonate, as shown in Table 1. The ethylenediamine core, octamethylenephosphonic acid terminated, PAMAM dendrimer is an antiscalant having a relatively low phosphorus content. Studies show that the octamethylenephosphonic acid terminated, PAMAM dendrimer provided in the present invention has a good inhibition scale efficiency under the condition of high concentration calcium, because of a special dendrimer structure thereof. Compared with the conventional phosphonate antiscalants widely used in the market, the octamethylenephosphonic acid terminated, PAMAM dendrimer has a good calcium tolerance, and will provide better inhibiting scale performance under high calcium concentration.

The E-PAMAM(PO₃H₂)₈ provided in the present invention is able to effectively inhibit the formation of scales, such as calcium carbonate, calcium sulfate, barium sulfate and calcium phosphate. The E-PAMAM(PO₃H₂)₈ has a good calcium tolerance, and can be widely used in circulating cooling water system having a high concentration multiple, boiler water, oil field water, sea water desalination, etc.

These and other objectives, features, and advantages of the present invention will become apparent from the following detailed description, the accompanying drawings, and the appended claims.

### DETAILED DESCRIPTION OF THE PREFERRED EMBODIMENT

The scale inhibitors in the following comparison examples are all commercially available.

### Comparison Example 1

micromolecular phosphonate antiscalant 2-phosphonobutane-1,2,4-tricarboxylic acid (PBTCA)

### Comparison Example 2

micromolecular phosphonate antiscalant amino trimethylene phosphonic acid (ATMP)

### Comparison Example 3

micromolecular phosphonate antiscalant ethylene diamine tetra(methylene phosphonic acid) (EDTMP)

### Comparison Example 4

micromolecular phosphonate antiscalant hexane diamine tetra(methylene phosphonic acid) (HDTMP)

### Comparison Example 5

macromolecular oligomer phosphonate antiscalant polyamino polyether tetra(methylene phosphonic acid) (PAPEMP)

### Example 1

### Preparation of Ethylenediamine Core, Octamethylenephosphonic Acid Terminated, PAMAM Dendrimer

16.57 g of phosphorous acid (99.0%, 0.200 mol) and 25.69 g of concentrated hydrochloric acid (37%, 0.26 mol) were placed, respectively, in a four-necked flask equipped with a condenser, a stirring, a thermometer and a dropping funnel. Next, 51.60 g of E-PAMAM(NH₂)₄ (25%, 0.025 mol) was slowly added to above mixture solution with cooling and stirring in such a rate to maintain temperature less than 40° C. The resulting mixture was heated to 90° C., and 20.27 g of formaldehyde solution (37%, 0.25 mol) was then added to the mixture with stirring to form a reaction mixture. The temperature of reaction mixture maintained at 90° C. for 1 hour, and then was elevated to 102˜105° C. for a reflux period of 4 hours. After the reflux, reaction mixture was concentrated for about 1 hour at 105° C., and meanwhile, hydrochloric acid was removed off with HCl absorption bottle. Next, the reaction mixture was cooled to ambient temperature, to give an amber transparent liquid product with 38% by weight. The identity of the product is confirmed as ethylenediamine core, octamethylenephosphonic acid terminated, PAMAM dendrimer (E-PAMAM(PO₃H₂)₈) by nuclear magnetic resonance spectroscopy (NMR) analysis as following:

¹³C NMR (D₂O): δ 34.02; 36.41; 49.92; 50.50; 56.62; 57.18; 176.01.

³¹P NMR (D₂O): δ 10.17.

### Examples 2˜4

### Preparation of Ethylenediamine Core, Octamethylenephosphonic Acid Terminated, PAMAM Dendrimer

Examples 2˜4 illustrate the preparation of ethylenediamine core, octamethylenephosphonic acid terminated, PAMAM dendrimer at various weight ratio of E-PAMAM(NH₂)₄/H₃PO₃/HCHO/HCl as shown in Table 2.

TABLE 2
Raw material ratios

| | E-PAMAM(NH₂)₄ | H₃PO₃ | HCHO | HCl |
|---|---|---|---|---|
| Ex. No. | (25%) | (99.0%) | (37%) | (37%) |
| Example 2 | 61.92 | 20.13 | 26.76 | 30.19 |
| Example 3 | 72.24 | 23.77 | 30.00 | 37.00 |
| Example 4 | 57.80 | 18.90 | 24.52 | 29.90 |

### Example 5

### Scale Inhibition Efficiency Test

The static testes for the inhibition efficiency of the antiscalants on calcium carbonate, calcium sulfate and calcium phosphate scale precipitation were performed as following methods. Static inhibition efficiency test for calcium carbonate were performed by referring to national standard of the People's Republic of China, calcium carbonate deposition method for testing scale inhibiting performance of water treatment agent (GB/T 16632-2008). The 500 mL of test solution containing 10 mg·L⁻¹ of antiscalant (dry basis), 240 mg·L⁻¹ of Ca²⁺ and 732 mg·L⁻¹ of HCO₃⁻ was prepared by adding calculated volume antiscalant stock solution, calcium stock solution, bicarbonate stock solution and double distilled water, respectively, to a glass bottle. The pH of each test solution was adjusted to 9.0 by using borate buffer Solution. The bottles were incubated in a water bath for 18 hour at 80° C. After cooling, an aliquot quantity was filtered through 0.22 μm filter paper, and then the calcium concentration in the filtrate was measured using the standard EDTA titration method. Meanwhile, the control test in the absence of antiscalant was conducted. Static inhibition efficiency test for calcium sulfate were performed similar to the static calcium carbonate inhibition efficiency. The 500 mL of test solution contained 5 mg·L⁻¹ of antiscalant (dry basis), 2200 mg·L⁻¹ of Ca²⁺ and 7350 mg·L⁻¹ of SO₄²⁻. It was adjusted to 7.00±0.1 by the addition of HCl and/or NaOH solution (10%). The bottles were incubated in a water bath for 18 hour at 80° C. After cooling, an aliquot quantity was filtered through 0.22 μm filter paper, and then the calcium concentration in the filtrate was measured by using the standard EDTA titration method. Meanwhile, the control test in the absence of antiscalant was conducted.

Static inhibition efficiency test for calcium phosphate were performed by referring to national standard of the People's Republic of China, calcium phosphate deposition method for testing scale inhibiting performance of water treatment agent (GB/T 22626-2008). The 500 mL of test solution containing 10 mg·L⁻¹ of antiscalant (dry basis), 240 mg·L⁻¹ of Ca²⁺ and 5 mg·L⁻¹ of PO₄³⁻ were prepared by adding calculated volume antiscalant stock solution, calcium stock solution, phosphate stock solution and double distilled water, respectively, to a glass bottle. The pH of each test solution was adjusted to 9.0 by using borate buffer solution. The bottles were incubated in a water bath for 18 hour at 80° C. After cooling, an aliquot quantity was filtered through 0.22 μm filter paper, and then the phosphate concentration in the filtrate was measured using the ammonium molybdate spectrophotometric method. Meanwhile, the control test in the absence of antiscalant was conducted.

The inhibition scale efficiency of the antiscalant is calculated by:

Inhibition (%)=[(Cᵢ−C_{control})/(C₀−C_{control})]×100%

Where: Cᵢ is the calcium or phosphonate concentration of the sample with the addition of the polymeric inhibitor after incubation, C_{control} is the calcium or phosphonate concentration of the sample with the addition of the scale inhibitor before incubation, C₀ is the calcium or phosphonate concentration of the sample without of the addition of the scale inhibitor after incubation.

TABLE 3
Result of scale inhibition efficiency test

| | | | Inhibition | Inhibition |
|---|---|---|---|---|
| | | Inhibition | efficiency | efficiency |
| | | efficiency | for | for |
| | | for CaCO₃ | CaSO₄ | Ca₃(PO₄)₂ |
| Ex. No. | Antiscalants | (%) | (%) | (%) |
| Example 1 | E-PAMAM(PO₃H₂)₈ | 77.70 | 100 | 48.63 |
| Example 2 | E-PAMAM(PO₃H₂)₈ | 76.45 | 99.65 | 45.54 |
| Example 3 | E-PAMAM(PO₃H₂)₈ | 77.06 | 100 | 47.89 |
| Example 4 | E-PAMAM(PO₃H₂)₈ | 77.37 | 99.60 | 45.26 |
| Comparison | PBTCA | 70.98 | 32.73 | 14.58 |
| example 1 | | | | |
| Comparison | ATMP | 54.21 | 82.12 | 22.62 |
| example 2 | | | | |
| Comparison | EDTMP | 57.81 | 88.86 | 22.33 |
| example 3 | | | | |
| Comparison | HTDMP | 65.77 | 87.22 | 23.19 |
| example 4 | | | | |
| Comparison | PAPEMP | 74.57 | 95.29 | 40.34 |
| example 5 | | | | |

Table 3 summarizes static scale inhibition efficiency tests for the ethylenediamine core, octamethylenephosphonic acid terminated, PAMAM dendrimer (E-PAMAM(PO₃H₂)₈) as well as several prior art antiscalants The inhibition eddiciency on CaCO₃, CaSO₄ and Ca₃(PO₄)₂ of the E-PAMAM(PO₃H₂)₈ is much better than micromolecule phosphonate antiscalants PBTCA, ATMP, EDTMP and HTDMP in comparison examples 1˜4, and also better than macromolecular oligomer phosphonate PAPEMP.

### Example 6

### The Effect of the Antiscalant Concentration on the Inhibition Efficiency of Calcium Carbonate Scale

500 mL of test solution containing a certain concentration of antiscalant, 200 mg·L⁻¹ of Ca²⁺ (500 mg·L⁻¹ as CaCO₃) and 732 mg·L⁻¹ of HCO₃⁻ was prepared by adding calculated volume antiscalant stock solution, calcium stock solution, bicarbonate stock solution and double distilled water, respectively, to a glass bottle. The pH of each test solution was adjusted to 9.0 using borate buffer solution. The bottles were incubated in a water bath for 10 hour at 80° C. After cooling, an aliquot quantity was filtered through 0.22 μm filter paper, and then the calcium concentration in the filtrate was measured using the standard EDTA titration method. Meanwhile, the control test in the absence of antiscalant was conducted.

TABLE 4
The effect of antiscalant concentrations on the inhibition efficiency of calcium carbonate

| | | Inhibition efficiency for CaCO₃ (%) | | | | | | | |
|---|---|---|---|---|---|---|---|---|---|
| | | Antiscalant Concentration (mg · L⁻¹) | | | | | | | |
| Ex. No. | Antiscalants | 2 | 4 | 6 | 8 | 10 | 12 | 14 | 16 |
| Example 1 | E-PAMAM(PO₃H₂)₈ | 34.29 | 50.32 | 64.51 | 92.63 | 95.12 | 96.23 | 100 | 100 |
| Example 2 | E-PAMAM(PO₃H₂)₈ | 33.21 | 47.18 | 61.11 | 92.11 | 94.77 | 94.98 | 100 | 100 |
| Example 3 | E-PAMAM(PO₃H₂)₈ | 34.12 | 49.13 | 63.99 | 93.02 | 92.89 | 96.33 | 100 | 100 |
| Example 4 | E-PAMAM(PO₃H₂)₈ | 32.64 | 48.37 | 62.9 | 87.02 | 91.79 | 95.55 | 100 | 100 |
| Comparison | PBTCA | 57.12 | 66.39 | 72.94 | 78.23 | 82.53 | 86.36 | 86.23 | 84.19 |
| example 1 | | | | | | | | | |
| Comparison | ATMP | 50.55 | 60.18 | 69.54 | 73.89 | 72.31 | 70.99 | 70.17 | 70.15 |
| example 2 | | | | | | | | | |
| Comparison | EDTMP | 48.11 | 56.32 | 66.84 | 73.83 | 80.58 | 79.45 | 78.23 | 77.22 |
| example 3 | | | | | | | | | |
| Comparison | HTDMP | 42.88 | 54.43 | 61.84 | 70.86 | 82.62 | 85.75 | 86.22 | 87.58 |
| example 4 | | | | | | | | | |
| Comparison | PAPEMP | 30.64 | 46.33 | 64.11 | 77.22 | 84.24 | 90.22 | 95.32 | 100 |
| example 5 | | | | | | | | | |

Table 4 summarizes the effect of the antiscalant concentration on the inhibition calcium carbonate scale efficiency. It is shown that micromolecular phosphonate antiscalants exhibit an obvious “threshold effect”, indicating that after the dosage of phosphonate exceeds a certain value (12 mg·L⁻¹ for PBTCA, 8 mg·L⁻¹ for ATMP, 10 mg·L⁻¹ for EDTMP, and 14 mg·L⁻¹ for HTDMP) the inhibition efficiency is not enhanced, but will reduce with further increase of phosphonate concentration. Because the micromolecular phosphonate antiscalants can combine with the calcium ions to form Ca-phosphonate precipitates, which can decreases the effective concentration of the antiscalant and causes a decreasing of the inhibition scale efficiency.

However, the inhibition efficiency of the ethylenediamine core, octamethylenephosphonic acid terminated, PAMAM dendrimer (E-PAMAM(PO₃H₂)₈) prepared in the present invention improves with the increase of its concentration in the range of experimental concentrations. When its concentration exceeds 8 mg·L⁻¹, the inhibition scale efficiency of E-PAMAM(PO₃H₂)₈ is better than all of the micromolecular phosphonate antiscalants in the comparison examples 1˜4. The E-PAMAM(PO₃H₂)₈ is able to inhibit the formation of calcium carbonate completely, and is better than the oligomer phosphonate PAPEMP in comparison example 5, which shows that the ethylenediamine core, octamethylenephosphonic acid terminated, PAMAM dendrimer (E-PAMAM(PO₃H₂)₈) in the present invention is not easy to combine with the calcium ions to form Ca-phosphonate precipitates.

### Example 7

### The Inhibition Scale Efficiency Under the Condition of High Calcium Concentration

The 500 mL of test solution containing a certain concentration of antiscalant, 600 mg·L⁻¹ of Ca²⁺ (1500 mg·L⁻¹ as CaCO₃) and 750 mg·L⁻¹ of HCO₃⁻ was prepared by adding calculated volume antiscalant stock solution, calcium stock solution, bicarbonate stock solution and double distilled water, respectively, to a glass bottle. The pH of each test solution was adjusted to 9.0 using borate buffer solution. The bottles were incubated in a water bath for 10 hour at 80° C. After cooling, an aliquot quantity was filtered through 0.22 μm filter paper, and then the calcium concentration in the filtrate was measured by using the standard EDTA titration method. Meanwhile, the control test in the absence of antiscalant was conducted.

TABLE 5
The effect of antiscalant concentrations on the inhibition calcium
carbonate efficiency under the calcium-enriched condition

| | | Inhibition efficiency for | | | | |
|---|---|---|---|---|---|---|
| | | CaCO₃ (%) Antiscalant | | | | |
| | | Concentration (mg · L⁻¹) | | | | |
| Ex. No. | Antiscalants | 5 | 10 | 20 | 30 | 40 |
| Example 1 | E-PAMAM(PO₃H₂)₈ | 24.55 | 58.32 | 79.96 | 83.21 | 85.96 |
| Example 2 | E-PAMAM(PO₃H₂)₈ | 23.81 | 58.04 | 78.96 | 81.44 | 83.33 |
| Example 3 | E-PAMAM(PO₃H₂)₈ | 25.03 | 58.88 | 77.51 | 83.51 | 85.55 |
| Example 4 | E-PAMAM(PO₃H₂)₈ | 24.12 | 57.91 | 78.38 | 82.96 | 84.01 |
| Comparison | PBTCA | 20.94 | 44.11 | 45.22 | 35.22 | 34.21 |
| example 1 | | | | | | |
| Comparison | ATMP | 15.06 | 21.92 | 30.4 | 20.33 | 18.22 |
| example 2 | | | | | | |
| Comparison | EDTMP | 17.21 | 30.89 | 40.99 | 31.99 | 24.38 |
| example 3 | | | | | | |
| Comparison | HTDMP | 16.9 | 40.36 | 55.06 | 45.06 | 40.19 |
| example 4 | | | | | | |
| Comparison | PAPEMP | 15.33 | 44.11 | 66.22 | 77.44 | 80.1 |
| example 5 | | | | | | |

Table 5 summarizes the effect of the antiscalant concentration on the inhibition calcium carbonate scale efficiency under the condition of high calcium concentration.

It is shown that the ethylenediamine core, octamethylenephosphonic acid terminated, PAMAM dendrimer (E-PAMAM(PO₃H₂)₈) in the present invention has an excellent scale inhibiting performance under the condition of high calcium concentration. With the increasing of the dosage of the antisalants, micromolecule phosphonate antiscalants in comparison examples 1˜4 combine easily with the higher concentration calcium ions to form Ca-phosphonate precipitates, which causes the sharp decreasing of the inhibiting scale efficiency. However, the E-PAMAM(PO₃H₂)₈ in the present invention can still remain a high scale inhibiting rate, and is better than the oligomer phosphosnate PAPEMP in comparison example 5, which shows that the ethylenediamine core, octamethylenephosphonic acid terminated, PAMAM dendrimer (E-PAMAM(PO₃H₂)₈) in the present invention is not easy to combine with the calcium ions to form Ca-phosphonate precipitates, and has a good calcium tolerance.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. An ethylenediamine core, octamethylenephosphonic acid terminated, PAMAM dendrimer, having a structure illustrated as follows:

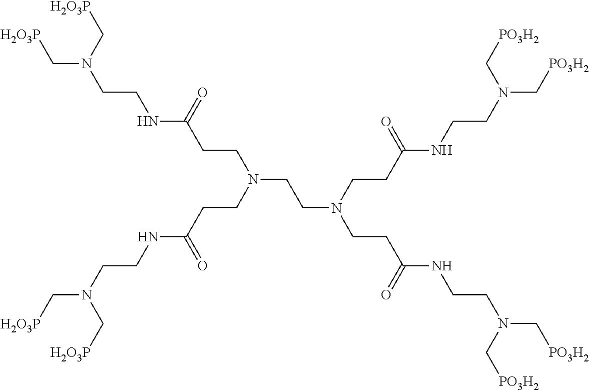

2. A preparation method of the ethylenediamine core, octamethylenephosphonic acid terminated, PAMAM dendrimer, as recited in claim 1, wherein a general reaction equation is as follows:

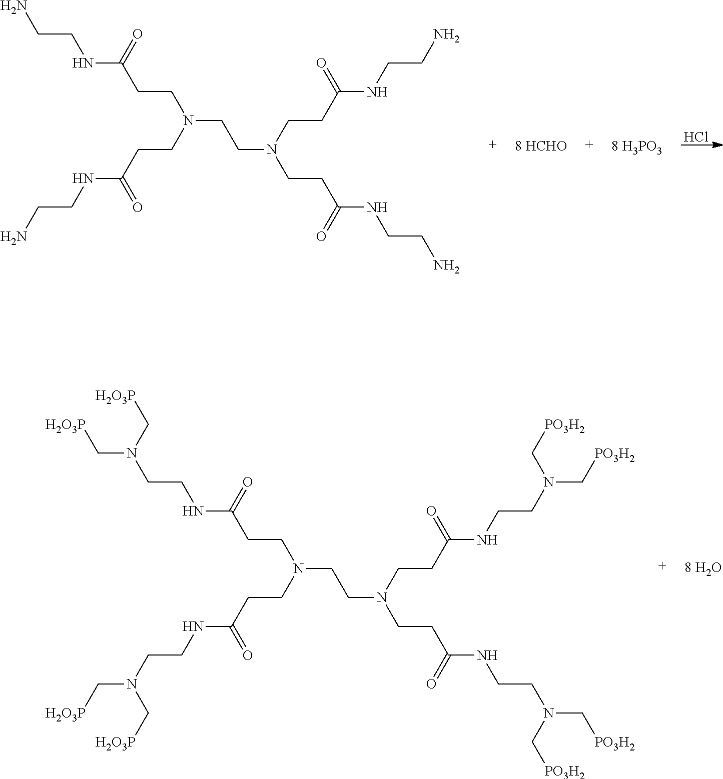

3. The preparation method of the ethylenediamine core, octamethylenephosphonic acid terminated, PAMAM dendrimer, as recited in claim 2, wherein specific steps are as follows, wherein phosphorous acid and concentrated hydrochloric acid are placed, respectively, in a four-necked flask equipped with a condenser, a stirring, a thermometer and a dropping funnel, next, ethylenediamine core, 0 generation, PAMAM dendrimer solution (25% in water) is slowly added to above mixture solution with cooling and stirring in such a rate to maintain temperature less than 40° C., the resulting mixture is heated to 85˜90° C., and formaldehyde solution is then added to the mixture with stirring to form a reaction mixture, the temperature of reaction mixture maintained at 85˜90° C. for 1˜2 hour, and then is elevated to 102˜105° C. for a reflux period of 4˜6 hours, after the reflux, reaction mixture is concentrated for about 1 hour at 105° C., and meanwhile, hydrochloric acid is removed off with HCl absorption bottle; next, the reaction mixture is cooled to ambient temperature, to give an amber transparent liquid product with 30˜40% by weight, i.e., the ethylenediamine core, octamethylenephosphonic acid terminated, PAMAM dendrimer.

4. The preparation method of the ethylenediamine core, octamethylenephosphonic acid terminated, PAMAM dendrimer, as recited in claim 2, wherein a molar ratio of the E-PAMAM(NH₂)₄, phosphorous acid, formaldehyde and concentrated hydrochloric acid is 1:(8.0˜8.2):(10.0˜11.0):(10.0˜10.5).

5. The preparation method of the ethylenediamine core, octamethylenephosphonic acid terminated, PAMAM dendrimer, as recited in claim 3, wherein a molar ratio of the E-PAMAM(NH₂)₄, phosphorous acid, formaldehyde and concentrated hydrochloric acid is 1:(8.0˜8.2):(10.0˜11.0):(10.0˜10.5).

6. A method of inhibiting the formation and deposition of scale include calcium carbonate, calcium sulfate and calcium phosphate in the industrial water systems comprising boiler, cooling, desalination, and oil production, comprising introducing into said water systems an effective scale inhibiting amount of the ethylenediamine core, octamethylenephosphonic acid terminated, PAMAM dendrimer having the formula recited in claim 1.

7. The method, as recited in claim 6, wherein the industrial water systems are under high calcium concentration.
